(19) United States
(12) Patent Application Publication
(10) Pub. No.: US 2026/0179101 A1
(43) Pub. Date: Jun. 25, 2026

(54) LEAD MANAGEMENT AND SINGLE POINT OF CONTACT CONTROL SYSTEM AND METHOD THEREOF

(71) Applicant: Eugene Doubleday, III, Alpharetta, GA (US)

(72) Inventor: Eugene Doubleday, III, Alpharetta, GA (US)

(21) Appl. No.: 18/991,507

(22) Filed: Dec. 21, 2024

(51) Int. Cl. G06Q 30/01; G06Q 10/0631; G06Q 10/0639; G06Q 10/10

(52) U.S. Cl. CPC G06Q 30/01; G06Q 10/063112; G06Q 10/063114; G06Q 10/06398; G06Q 10/103

(57) ABSTRACT

A method, a system and a computer program product for lead management and SPOC control are disclosed. The method includes integrating CRM systems and vendor systems to access lead and vendor data into a lead management system. The method also includes assigning a first lead to a first agent via a lead management module. The method further includes assigning a DID number and a masked email address to the first lead, and routing all communication through lead management system to ensure secure, centralized, and compliant interactions. The method includes dynamically tracking first agent's compliance with lead retention conditions. The method also includes automatically reassigning first lead to a second agent if the first agent is non-compliant with the plurality of lead retention conditions. The method further includes providing a color-coded UI that visually displays lead status and agent compliance for monitoring both lead engagement levels and agent performance.

### FIELD OF THE INVENTION

The present invention relates to customer relationship management (CRM) systems and more particularly relates to lead management and single point of contact control system and method thereof.

### BACKGROUND OF THE INVENTION

Efficient lead management and the ability to control agent interactions with leads are fundamental to customer relationship management (CRM) systems, particularly when companies rely on both internal and external agents. Existing lead management systems provide limited flexibility for controlling lead assignments, enforcing compliance, securing lead contact information, and engaging with leads in alignment with organizational policies. These limitations create a series of challenges, including lack of communication, loss of lead ownership, compliance risks, and limited customer satisfaction. Conventional CRM systems lack essential capabilities, making it difficult for businesses to enforce structured management and to provide single points of contact (SPOC) for seamless customer experience.

One of the core limitations of existing systems is the absence of a lead management and single point of contact (SPOC) control system that integrates a range of functionalities, including CRM integration, lead assignment toggling, dynamic compliance, milestone tracking, and secure communication toggling. These limitations hinder the system's ability to dynamically control agent interactions, manage sensitive customer information securely, and align communication practices with customer preferences and compliance requirements. Specifically, current systems lack in several essential features. For example, although conventional lead management systems integrate with CRMs used across different organizations, it lacks in centralized control of leads across various platforms thus leading to inconsistency in lead management.

Further, traditional systems lack the flexibility to dynamically assign and toggle lead contacts between agents, particularly between internal and external agents. Also, there is no specific parameter taken into account for assigning leads to agents, wherein the parameters may include agent's performance metrics. It is also lacking in automatic and dynamic toggling capability based on real-time needs. Thus, this results in inefficient assignment of leads, especially urgent leads.

Conventional systems also lack in providing a structured way to integrate competitive pricing with procurement requirements. Masking calls and emails of leads handled by external agents protects sensitive lead information. However, existing lead management system lacks in secure, customizable toggling capabilities in sharing contact information and controlling call/email masking. Existing systems further lacks in real-time compliance enforcement, especially for external agents and in supporting lead splits between agents.

Consequently, there is a need for a lead management system that addresses these limitations by integrating advanced toggling capabilities, allowing organizations to securely manage lead information, enforce dynamic compliance protocols, and facilitate seamless single point of contact (SPOC) assignments. By incorporating these features, such a system enhances lead management efficiency, improves security and compliance, and significantly enhances customer satisfaction.

### BRIEF SUMMARY OF THE INVENTION

It is an objective of the present invention to provide a lead management and SPOC control system that integrates with multiple CRM and vendor management systems within an organization.

It is another objective of the present invention to provide a lead management system that enables dynamic assignment and toggling of lead contacts to external agents.

It is yet another objective of the present invention to allow automatic SPOC assignment, thereby ensuring consistent lead-agent communication.

It is further objective of the present invention to provide a lead management that facilitate competitive pricing options contingent upon procurement requirement submissions from customers.

It is another objective of the present invention to provide a lead management that maintain the confidentiality of lead contact information through DID assignment for enhanced SPOC integrity.

It is further objective of the present invention to enforce access controls and lead assignment by a lead management system based on adaptive compliance requirements while ensuring regulatory adherence for external agents.

It is another objective of the present invention to centralize lead information, including status updates, agent performance, and customer preferences, within a secure database.

It is yet another objective of the present invention to allow leads to control communication preferences, such as method, frequency, and opt-in or opt-out settings.

It is further objective of the present invention to enable masked communication by utilizing DID numbers and anonymized emails to secure private information and facilitate compliant interactions.

It is another objective of the present invention to allow organization to define and enforce lead retention requirements.

It is yet another objective of the present invention to prevent conflicts between independent and direct agents through access control toggling, thus minimizing channel conflicts.

It is further objective of the present invention to provide a color-coded interface by a lead management system for visual differentiation of lead statuses, compliance adherence, and milestone achievements, with integration capabilities for third-party systems.

It is another objective of the present invention to allow real-time priority toggling for urgent leads, dynamically adjusting lead distribution based on agent performance and lead urgency.

According to an embodiment of the present invention, a method for lead management using a lead management system is disclosed. The method includes integrating a plurality of customer relationship management (CRM) systems and vendor systems into a lead management system, via one or more application programming interfaces (APIs), and using a lead integration module to access lead and vendor data across the client's organization. The method also includes assigning a first lead of a plurality of leads to a first agent of a plurality of agents via a lead management module. The method further includes assigning a direct inward dial (DID) number and a masked email address to the first lead through a communication module, and routing all communication through the lead management system to ensure secure, centralized, and compliant interactions. The method includes dynamically tracking first agent's compliance with a plurality of lead retention conditions, using an agent tracking module, that updates lead status in real-time based on agent performance metrics. The method also includes automatically reassigning the first lead to a second agent if the first agent is non-compliant with the plurality of lead retention conditions The method further includes providing a color-coded user interface (UI) that visually displays lead status and agent compliance for monitoring both lead engagement levels and agent performance within the lead management system.

According to an embodiment, a system comprising a processor and memory to implement a method is disclosed. The method includes integrating a plurality of customer relationship management (CRM) systems and vendor systems into a lead management system, via one or more application programming interfaces (APIs), and using a lead integration module to access lead and vendor data across the client's organization. The method also includes assigning a first lead of a plurality of leads to a first agent of a plurality of agents via a lead management module. The method further includes assigning a direct inward dial (DID) number and a masked email address to the first lead through a communication module, and routing all communication through the lead management system to ensure secure, centralized, and compliant interactions. The method includes dynamically tracking first agent's compliance with a plurality of lead retention conditions, using an agent tracking module, that updates lead status in real-time based on agent performance metrics. The method also includes automatically reassigning the first lead to a second agent if the first agent is non-compliant with the plurality of lead retention conditions The method further includes providing a color-coded user interface (UI) that visually displays lead status and agent compliance for monitoring both lead engagement levels and agent performance within the lead management system.

According to an embodiment, a computer-program product including a non-transitory computer-usable medium having computer-readable program code embodied therein is disclosed. The computer-readable program code is adapted to be executed to implement a method. The method includes integrating a plurality of customer relationship management (CRM) systems and vendor systems into a lead management system, via one or more application programming interfaces (APIs), and using a lead integration module to access lead and vendor data across the client's organization. The method also includes assigning a first lead of a plurality of leads to a first agent of a plurality of agents via a lead management module. The method further includes assigning a direct inward dial (DID) number and a masked email address to the first lead through a communication module, and routing all communication through the lead management system to ensure secure, centralized, and compliant interactions. The method includes dynamically tracking first agent's compliance with a plurality of lead retention conditions, using an agent tracking module, that updates lead status in real-time based on agent performance metrics. The method also includes automatically reassigning the first lead to a second agent if the first agent is non-compliant with the plurality of lead retention conditions The method further includes providing a color-coded user interface (UI) that visually displays lead status and agent compliance for monitoring both lead engagement levels and agent performance within the lead management system.

### BRIEF DESCRIPTION OF DRAWINGS

The present invention will become clearly understood to those of ordinary skill in the art when descriptions of exemplary embodiments thereof are read with reference to the accompanying drawings.

FIG. 1 is a simplified block diagram of a lead management system according to an embodiment of the present invention.

FIG. 2 is a block flow diagram of the lead management system of FIG. 1.

FIG. 3 is a detailed block flow diagram of the lead management system of FIG. 1 depicting lead assignment toggle.

FIG. 4 is a block flow diagram of the lead management system of FIG. 1 depicting lead assignment and reassignment process.

FIG. 5 is a schematic view of an agent tracking module of the lead management system of FIG. 1.

FIG. 6 is a schematic flow diagram of an agent scoring engine and subsequent process associated with scoring agent's performance.

FIG. 7 is a flowchart illustrating a best pricing sharing process.

FIG. 8 is a flowchart illustrating lead splitting process.

FIG. 9 is a schematic view depicting toggles of the lead management system of FIG. 1 handled by the client/organization.

FIG. 10 is an example user interface of the lead management system of FIG. 1.

FIG. 11 is another example user interface of the lead management system of FIG. 1.

FIG. 12 is a block diagram of a computer system.

FIG. 13 is a flowchart illustrating a method for lead management using a lead management system.

### DETAILED DESCRIPTION OF THE INVENTION

The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention. For a more complete understanding of the present invention, reference is now made to the following descriptions taken in conjunction with the accompanying drawings.

The present invention disclosed herein is a lead management system and method which can be applied across a wide range of industries for providing organizations with enhanced and efficient lead and vendor management capabilities, real-time data synchronization, and enhanced compliance tracking. Some key application areas includes: sales and marketing, wherein the sales teams manages large volumes of leads across multiple channels. By integrating with customer relationship management (CRM) systems, the lead management centralizes lead data, assigns leads dynamically to agents, and ensures compliance with organizational policies. The lead scoring and performance tracking algorithms help sales managers prioritize high-potential leads, improve agent accountability, and enhance customer engagement. Marketing teams can also use the platform to monitor campaign performance and manage leads generated through various marketing channels. For organizations with complex vendor networks, the lead management system simplifies supplier onboarding, compliance tracking, and requirement enforcement. The vendor management module streamlines operations by automating procurement-related tasks and ensuring adherence to regulatory and contractual obligations. This makes the platform valuable for industries like retail, manufacturing, and logistics, where vendor compliance is critical for smooth supply chain operations. The present invention enables independent agents to act as freelancers, offering modular services such as lead management and vendor compliance. This approach is well-suited for gig economy platforms, allowing independent agents to provide solutions to small and medium-sized businesses (SMBs). In the healthcare and insurance sectors, where lead management involves handling sensitive data, the secure architecture of present invention ensures compliance with regulations like HIPAA and GDPR. Insurance agents can use the lead management system to track potential customers, manage policy renewals, and ensure timely follow-ups. Healthcare providers can leverage the system to streamline patient onboarding, referral management, and vendor coordination. Further, educational institutions and recruitment agencies can utilize the lead management system to manage applicant leads effectively. In education, the lead management system can track prospective students, automate communication, and provide insights into enrollment trends. Recruitment agencies can use it to manage candidate profiles, assign recruiters to candidates, and ensure compliance with hiring protocols. The performance metrics and lead tracking features make it easier to evaluate and optimize recruitment strategies. In financial institutions and real estate agencies the lead management system manages high-value leads. For banks and financial advisors, the system can track loan applications, investment inquiries, and client interactions, ensuring compliance with financial regulations. In real estate, agents can use the lead management system to manage property listings, assign leads, and track sales processes. The dynamic toggling and compliance monitoring features ensure smooth workflows and regulatory adherence.

In this patent application, the term “lead management and single point of contact (SPOC) control system” is used interchangeably with other equivalent terms such as “lead management system,” “lead management platform,” “lead management software,” “lead management software application,” “vendor management system,” “vendor management platform,” “lead and vendor management system,” “lead and vendor management platform,” and similar nomenclature. These terms collectively refer to the system, platform, or software application designed to manage, track, and optimize leads, vendors, and associated workflows. The use of these alternative terms throughout the application is intended to encompass all variations and implementations of the described system without limiting its scope or functionality. The term “lead” is used interchangeably with other equivalent terms such as “prospect,” “business prospect,” “opportunity lead,” “sales lead,” “engagement prospect,” and similar nomenclature. These terms collectively refer to clients of entities, individuals, or businesses that represent potential opportunities for engagement, sales, or interaction within the context of the described system. The use of these alternative terms throughout the application is intended to encompass all variations and interpretations of the term “lead” without limiting the scope or functionality of the described system.

Similarly, the term “client” is used interchangeably with other equivalent terms such as “organization,” “enterprise,” “business entity,” “company,” “institution,” “corporation,” “firm,” “customer organization,” “implementing entity,” “partner organization,” “end-user organization,” and similar nomenclature. These terms collectively refer to the organization, business, or entity where the described system is being implemented and utilized. The use of these alternative terms throughout the application is intended to encompass all variations and interpretations of the term “client” without limiting the scope or applicability of the described system.

The terms “agents,” “Single Point of Contact(s),” “SPOC,” “external agents,” “external sales agents,” “internal agents,” “internal sales agents,” “freelance agents,” and any other similar designations are used interchangeably throughout this document to refer to individuals or entities engaged in various roles related to the execution of tasks, responsibilities, or services within the context of the lead management system. “Internal agents” specifically refers to employees of the organization, while “external agents” refers to freelance workers who may be employed agents but are engaged on a non-permanent or contract basis. The term “agents” may refer to both internal and external agents, depending on the context.

The lead management and Single Point of Contact (SPOC) control system described herein is a software application that may be implemented as part of a computer system or as the computer system itself. The system's architecture, including its hardware and software components, is intended to provide a comprehensive solution for managing leads and facilitating streamlined communication, but its specific implementation may vary depending on the configuration and integration with existing infrastructure.

In various embodiments, the disclosure relates to a unified platform for lead distribution and managing across both independent and direct sales agents within customer relationship management (CRM) systems. In an exemplary aspect, the unified platform is described as a software application for use within an organizational asset, which is intended for performing all the lead management tasks and activities as known in the existing art and all novel and inventive aspects which are not known in the existing art. In various aspects, the independent sales agents are also referred to as external agents or outsourced agents while the direct sales agents are internal agents of an organization. Typically, companies rely on complex lead management frameworks involving multiple sales agents, including direct employees and external agents. These frameworks require robust controls over lead assignments, communication security, compliance monitoring, and performance-based retention criteria. However, existing CRM systems typically lack extensive capabilities to manage and oversee independent agents in a controlled yet flexible manner. The present invention addresses this need by providing companies with a centralized platform that facilitates secure communication, compliance monitoring, and dynamic engagement controls, while improving lead management efficiency and customer satisfaction.

By incorporating dynamic toggling capabilities, the present invention provides enhanced flexibility and control over lead assignments, agent interactions, and communication masking based on specific organization requirements and lead status. With this toggling functionality, the present invention enables companies to activate or deactivate settings such as lead assignment preferences, contact masking and procurement-related pricing provisions in real time. This adaptability ensures that companies can oversee independent agents in a controlled and customizable manner, with toggling options that support seamless adjustments to lead engagement, compliance, and retention needs. By integrating various toggling mechanisms in the software application, the present invention provides a versatile lead management solution that improves operational efficiency, ensures data privacy, and enhances customer satisfaction through agile control over engagement processes.

The present invention includes a lead management module, to centralize communication and support customer preferences. Through lead management module, customers, i.e. companies or organizations, can designate an agent as their SPOC, ensuring that all interactions are streamlined through a single contact. In various aspects, the SPOCs are referred to as agents, which may independent agents, or internal agents or employees. In some aspects, the present invention utilizes Direct Inward Dial (DID) numbers and email masking technologies to maintain secure, compliant communication that protect customer privacy. The controlled communication process prevents unauthorized access to sensitive information and fosters trust between the customer and the agent.

In addition to SPOC, the present invention provides a procurement requirement exchange capability that enables companies to establish procurement conditions as part of their engagement requirements. With this capability, leads are allowed submit their specific needs or procurement guidelines, which are then integrated into a pricing system of the unified platform. This aspect of the present invention allows companies to dynamically manage lead engagement by ensuring that procurement requirements are met prior to activating competitive pricing or advanced engagement settings.

A significant aspect of the present invention is the dynamic lead retention conditions for agents. Utilizing this aspect, companies are allowed to establish performance-based criteria that independent agents must meet to retain access to their assigned leads. In some embodiments, the company assigns the leads to agents based on the agent's roles or milestones. The lead retention aspect tracks agent activities and evaluates compliance with predefined conditions, including but not limited to engagement level, customer satisfaction, and response times. With this aspect, the platform dynamically updates lead status, and leads may be reassigned if agents fail to meet the required conditions. By incorporating performance-based criteria, the present invention enables companies to maximize lead retention while minimizing instances of lead neglect or misuse.

To ensure consistent and secure communication, the present invention employs masked communication mechanisms for both lead and agent contact number, and email addresses in some embodiments. The masking capabilities enable the platform to route all communications through the platform by masking real contact information to protect both customers and agents from unauthorized access or misuse of personal data. As a result, the present invention maintains high security standards for lead information, ensuring compliance with data privacy regulations and fostering secure engagement between customers and agents.

The present invention further includes a color-coded compliance interface that provides a visual overview of lead status, agent compliance, and performance metrics. By incorporating visual indicators, this color-coded compliance interface enables quick and easy monitoring of lead progression and agent activities, while supporting real-time decision-making for sales teams. Compliance indicators may include color-coded markers for completed, pending, or missed milestones, allowing companies to assess and manage lead distribution efficiently. The color-coded interface, such as an analytics dashboard, simplifies lead tracking by highlighting compliance concerns or engagement issues that require attention, thereby helping managers to make informed adjustments to lead assignments as needed.

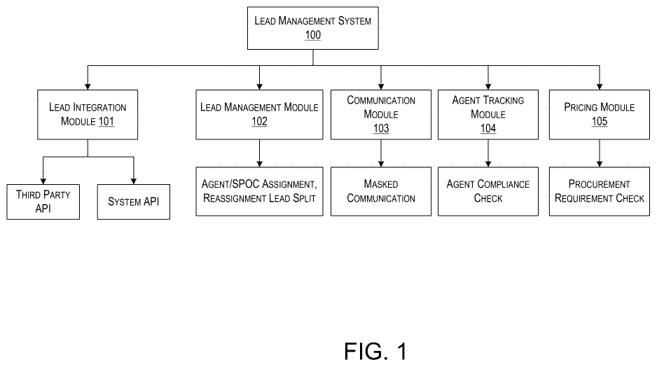

According to an embodiment of the present invention, a lead management system 100 is disclosed. The system 100 is configured to streamline and control leads within an organization. Referring FIG. 1, the system 100 includes a lead integration module 101, a lead management module 102, a communication module 103, an agent tracking module 104, a pricing module 105 and a central database 106.

The lead integration module 101 serves as the core interface connecting the lead management system 100 with one or more customer relationship management (CRM) systems and vendor management systems across an organization. The one or more CRM systems and vendor management systems are hereinafter referred to as client CRM systems. For example, CRM systems include but not limited to Salesforce, HubSpot, and Microsoft Dynamics. In one aspect, the lead integration module 101 establishes application programming interface (API)-based connections with client CRM systems, and allows for synchronized data sharing to access lead information from multiple sources in real-time. The API includes third-party API or lead management system's API. For example, the system 100 utilizes RESTful APIs to integrate the lead management system 100 with client CRM systems such as Salesforce or HubSpot. The integration helps manage leads across a plurality of teams and external agents of an organization, as it provides a unified view of all leads within the system, irrespective of the CRM platform.

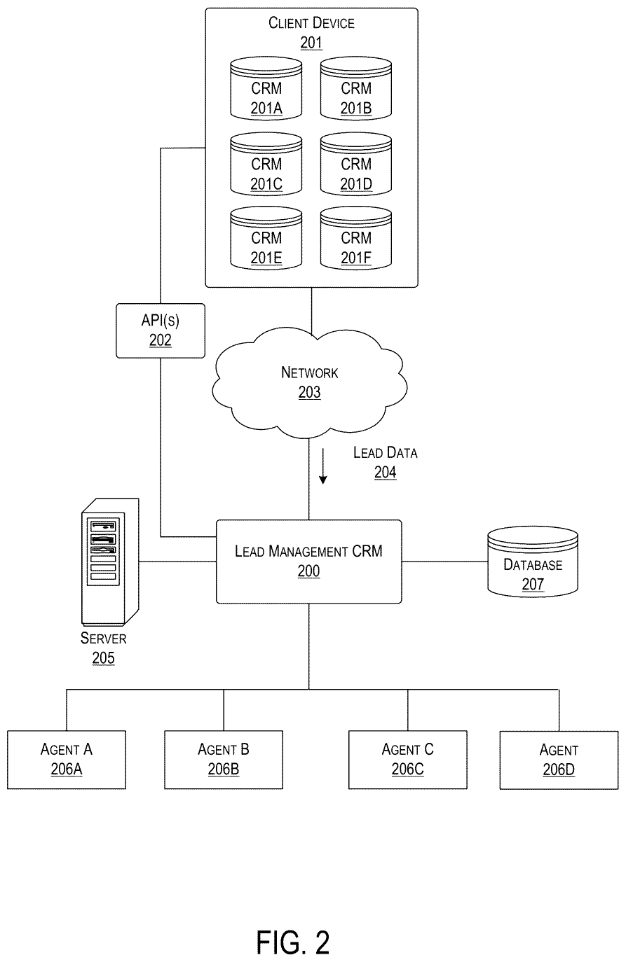

The lead management module 101 is configured to dynamically assign and toggle lead contacts to internal and external agents. In a specific aspect, this module 101 ensures that leads can be reassigned based on one or more parameters including but not limited to agent's response time, follow-up frequency, lead status tracking, compliance with protocols of organization, engagement matrix, availability, satisfaction or feedback rate, and target achievement, which are continuously updated in the system 100. For example, referring FIG. 2, a lead management system 200 establishes connection with a plurality of CRM systems 201A-201F of a client device 201, via one or more APIs 202, over a network 203. The lead management system 200 is connected with a lead management server 205 and a lead database 207. The lead management system 200, when integrates with the client device CRM systems 201, is able access a plurality of leads and lead related data 204, and stores it in the local lead database 207. The system 200 also depicts that the lead management system 200 connects with a plurality of agents 206A-206D. The agents 206A-206D may be client's agents, i.e. internal agents or external agents, i.e. independent agents.

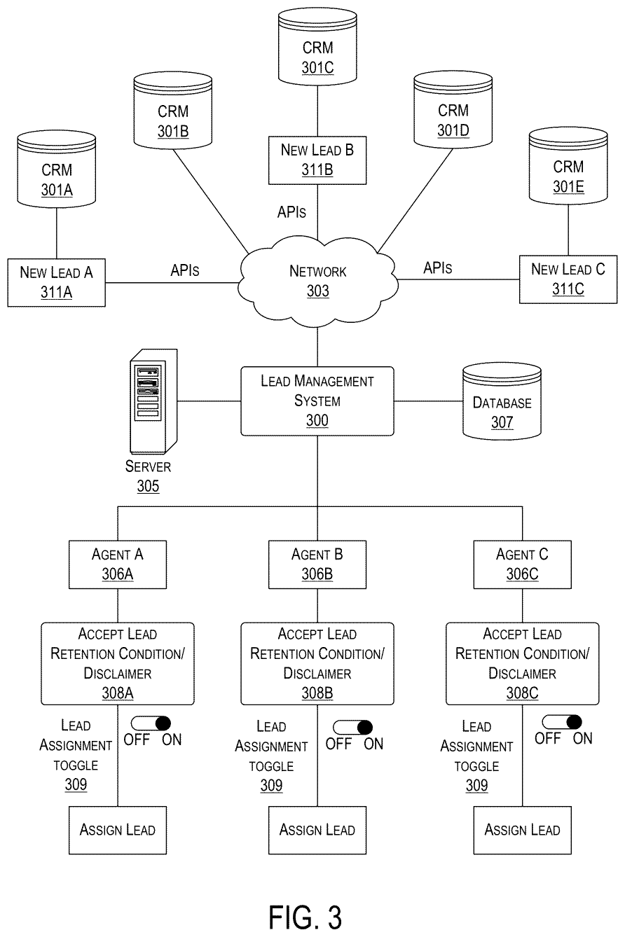

Referring FIG. 3, a lead management system 300 is depicted as another embodiment. The lead management system 300 is connected to a lead management server 305 and a lead database 307. In one aspect, the lead management system 300 integrates, i.e. communicates, with the client CRM systems 301A-301E continuously and in real-time, over a network 303. In one aspect, when one or more leads 311A-311C is newly updated in one of the CRM systems 301A-301E, the lead management system 300 consequently receives leads 311A-311C via APIs and stores the lead related data it in the database 307. In an exemplary aspect, the lead management system 300 is connected with a plurality of agents 306A-306C via respective user devices, wherein in some aspects, the user device each installed with the lead management system 300 to manage the leads. The number of leads 311A-311C, CRM systems 301A-301E and agents 306A-306C shown in the drawings is for illustration purpose only and it may vary depending upon the organization. In some embodiments, the toggling mechanisms may optionally be influenced by AI-driven insights, allowing for automated decisions based on agent performance, lead urgency, or compliance requirements.

Further depicted in FIG. 3 is the agent accepting lead retention conditions 308A-308C. The lead management module 102 includes a lead assignment toggle 309A-309C which may be activated or deactivated by the client. When the lead assignment toggle 309A-309C is activated, as and when the leads 311A-311C enters the lead management system 300, the lead management module 102 assigns the leads 311A-311C to individual agents 306A-306C. However, the agents 306A-306C is restricted to access the leads 311A-311C. This implies that the agents 306A-306C are allowed to access respective leads 311A-311C upon accepting the lead retention condition/disclaimer 308A-308C. This is due to the lead assignment toggle 309A-309C being in ON condition. In instances, where toggle 309A-309C is not activated, i.e. in OFF condition, the agents 306A-306C are allowed to access respective leads 311A-311C with or without accepting the lead retention condition/disclaimer 308A-308C. This implies that the acceptance of lead retention condition/disclaimer 308A-308C is optional.

In various embodiments, agents 306A-306C are referred to as a single point of contact (SPOC). In one aspect, the lead assignment toggle 309A-309C allows the SPOC level to be adjusted based on organizational needs. In some aspects, the module 102 enables toggling between different levels of SPOC assignment, either to individual leads or across all lead contacts within an organization. Such flexibility in SPOC assignment helps maintain consistent communication pathways while allowing toggling based on changes in agent roles, shifts, or lead reassignment needs.

In an exemplary embodiment, the agents 306A-306C receives, accepts, rejects and manages leads using their user device. The user device includes a desktop computer, a laptop, a tablet computer, a smart device, a mobile device and the like. In the user device, a graphical user interface (GUI) of the lead management system 300 initially displays the lead to be assigned to the agents 306A-306C along with the lead retention condition/disclaimer 308A-308C prompting the agent 306A-306C to accept or reject the conditions. The prompts of accept and reject are displayed in the form of icons or tabs. The agents 306A-306C are allowed to read lead retention condition/disclaimer 308A-308C and select accept or reject prompts. If the agents 306A-306C accepts, the leads 311A-311C are assigned to the agents 306A-306C, and then the agents 306A-306C are allowed to view all the data related to the leads 311A-311C and start communicating with the leads 311A-311C and managing the lead profiles.

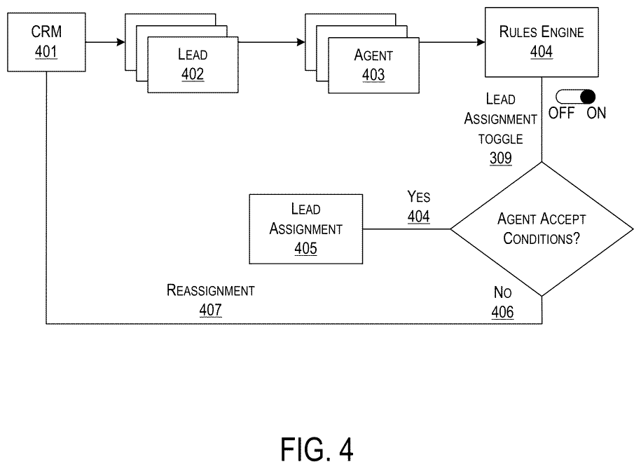

Referring FIG. 4, when a CRM 401, i.e. one of the aforementioned systems 200 and 300, transmits a profile of a lead 402 to an agent 403, a rules engine 404 provides the lead retention condition/disclaimer to the agent 403. If the agent 403 accepts 404 the conditions, the lead 402 is assigned to the agent 403 and if the agent rejects 406 the conditions, the lead 402 is feedback to the CRM 401 to reassign 407 the lead 402 to another agent.

In one embodiment, the system 100 enables a company to proactively assign a sales agent, independent representative, or employee as a Single Point of Contact (SPOC) for a specific lead, account, or group of accounts. The company-assigned SPOC functionality is implemented as follows: assignment process which involves the company selecting an agent or representative from the platform's interface, wherein the assignment process is based on performance metrics, account needs, or customer preferences; the system then tracks the SPOC assignment, including any milestones or performance metrics associated with the account; and routing communication with the designated agent-client account through the SPOC, using tools such as: blocking non-designated contact points and assigning a unique Direct Inward Dial (DID) number to the SPOC, ensuring all calls or messages are directed to the appropriate contact.

For example, a large enterprise customer with multiple divisions requests a single point of contact for all communications. Using the system 100, the company assigns Jane Doe, a high-performing independent agent, as the SPOC for the account. The platform generates a unique DID number for Jane, which is shared with the customer. All calls or communications to the account are redirected to Jane's DID, ensuring she is the sole representative engaging with the customer. Jane is responsible for meeting a specific milestone, such as scheduling quarterly review meeting. The system tracks her performance, notifies her of upcoming deadlines, and provides the company with real-time visibility into the status of the SPOC assignment. If milestones are not met, the system can revoke the SPOC assignment and reassign the account to another agent.

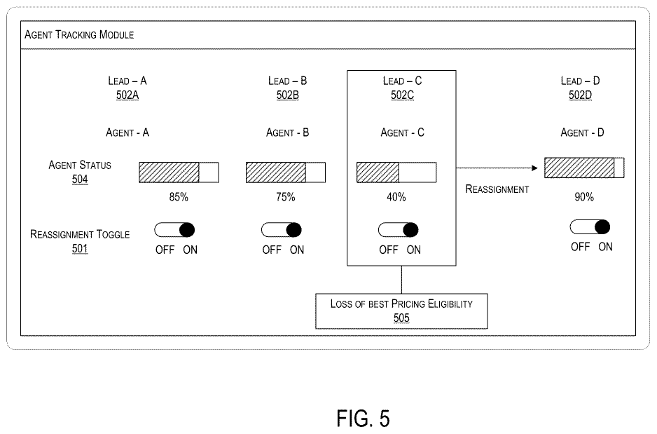

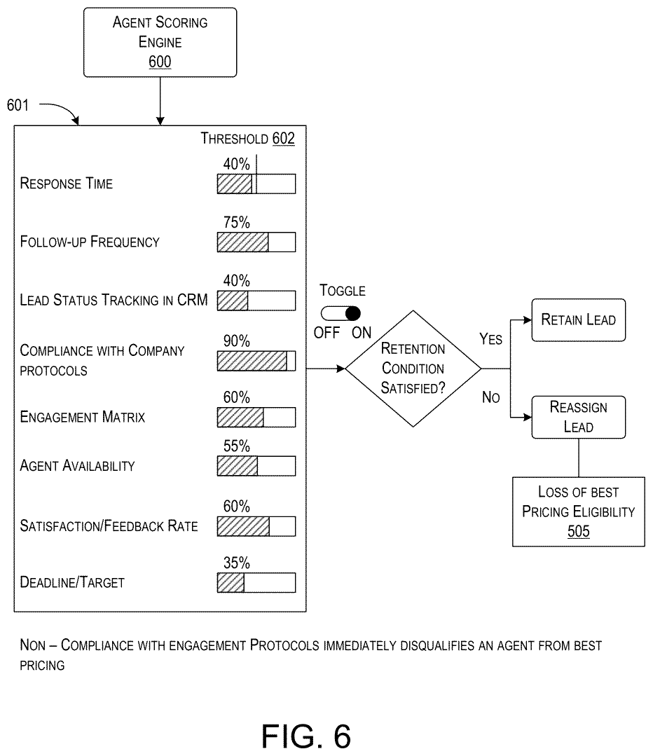

In one embodiment, the plurality of lead retention conditions includes threshold values that the agent should maintain or compliant with respect to several performance parameters including but not limited to the agent's response time, follow-up frequency, lead status tracking, compliance with protocols of organization, engagement matrix, availability, satisfaction or feedback rate, and target achievement. The threshold values are also referred to as agent's score. In an exemplary embodiment, the lead management system 100 dynamically tracks agent's compliance with the plurality of lead retention conditions using the agent tracking module 104 that updates lead/agent status in real-time based on agent performance metrics. An overview of the lead/agent status is shown in FIG. 5. The agent tracking module 503 is depicted as a GUI of the lead management system 100 where the client is allowed to view the status 502A-502D of each lead and agent respectively. The client is allowed to activate or deactivate of a reassignment toggle 501 configured in the agent tracking module 503. When the reassignment toggle 501 is activated, i.e. in ON condition, the agent tracking module 503 triggers or prompts the lead management module 102 to reassign the lead to another agent from present agent. Reassigning the lead tends the previous agent to lose 505 the best pricing eligibility for, which will be detailed in later sections of the description. The GUI displays the status 502A-502D of all the lead and respective agents as shown in FIG. 5 with the agent status score 504, i.e. threshold value. Referring FIG. 6, an agent scoring engine 600 is shown. The agent scoring engine 600 is configured in the agent tracking module 503 of FIG. 5. Various parameters 601 are periodically monitored and scored by the agent scoring engine 600 which is shown in FIG. 6. The scores are transmitted to the agent tracking module 503 to determine if the agent satisfies retention condition, i.e. whether the score of one or more parameters is below the threshold. If the values of one or more parameters 601 are below the threshold 602, and if the reassignment toggle 501 is ON, the lead management module 102 is prompted by the agent tracking module 503 to reassign the lead to another agent. As discussed in aforementioned description, previous agents are tend to lose 505 the best pricing eligibility for being on-compliance with engagement protocols, which will be detailed in later sections of the description If the values of one or more parameters 601 are above the threshold 602, and if the reassignment toggle 501 is ON, the lead management module 102 is prompted by the agent tracking module 503 to retain the lead with same agent.

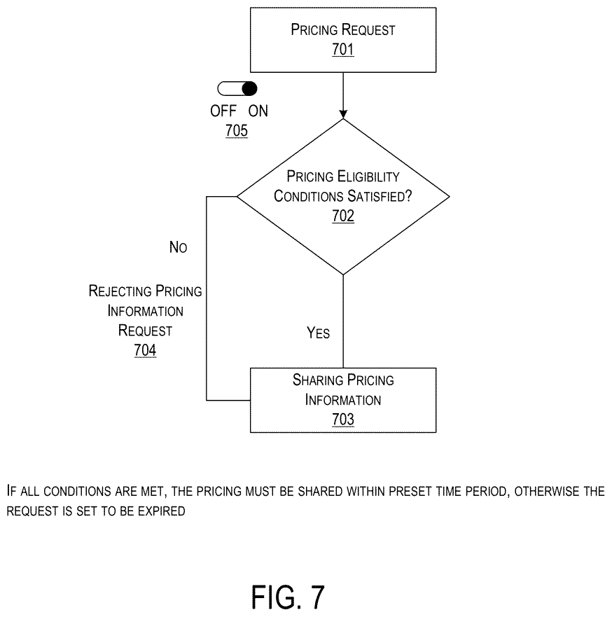

In some embodiments, the agent tracking module utilizes artificial intelligence (AI)/machine learning (ML) algorithms to dynamically analyze performance metrics, predict agent effectiveness, and trigger toggles for reassignment or compliance enforcement. These capabilities ensure optimal lead management by adapting to real-time data and historical trends. In one exemplary embodiment, the pricing module 105 is disclosed to provide pricing information, to the plurality of leads or client, about one or more services or products. The pricing module 105 includes a pricing toggle 705 which when enabled, i.e. if the toggle 705 is ON, shares 703 or rejects 704 pricing details based on one or more criteria. Referring FIG. 7, when the lead requests 701 pricing for one or more services or products to the agent, the pricing module 105 determines 702 if the best pricing eligibility condition is satisfied. In one aspect, the best pricing eligibility condition includes that the prospects must meet an agreed-upon timeframe for submitting their procurement requirements or making a decision. This condition is essential to qualify for best pricing, reinforcing the importance of timely engagement. In another aspect, the best pricing eligibility condition includes satisfying one or more agent-specific metrics, including but not limited to response time, follow-up frequency, and compliance with company protocols. As discussed in previous sections, when one or more agent-specific metrics are not satisfied, the lead is reassigned and that significantly impacts the best eligibility, implying that only agents who meet these performance criteria may handle best price-qualified leads. In yet another aspect, the best pricing eligibility condition includes that if a lead with best pricing eligibility is reassigned to a new agent, this may result in the loss of best pricing eligibility to the previous agent, depending on whether original conditions are still met. This ensures that best pricing remains tied to initial engagement commitments. In another aspect, the best pricing eligibility condition includes preset customized requirements for different prospects, implying that the organization has the flexibility to adjust best eligibility conditions on a per-lead basis.

According to satisfying aforementioned conditions, the agents are allowed to share 703 the best pricing or the leads are qualified to receiving the best pricing, i.e. the company's most competitive, best-available pricing for similar services. By activating this pricing toggle 705, the feature incentivizes the leads to share their requirements in exchange for optimal pricing and a streamlined, managed engagement process. Similarly, if the aforementioned conditions are not satisfied, the agents or the pricing module rejects 704 pricing request. In various aspects, if all pricing conditions are met, the pricing must be shared within preset time period. At instances when the pricing details are not shared within preset time period, the pricing request is set to be expired.

For example, in one embodiments, the system or the agents ensure best pricing to leads for comparable services, quantities, and terms. For instance, a client entering a 12-month agreement for a recurring service involving 1,000 units per month will receive pricing consistent with other clients under similar agreements. Such that the pricing is standardized, thereby ensuring fairness and eliminating discrepancies across similar contractual arrangements.

For example, in another embodiment, the system incorporates time-sensitive incentives to encourage prompt decision-making. For instance, a time-bound discount may be offered, such as a 10% reduction in service costs if the agreement is executed by a specified date. The system enables customization of incentive parameters, including the percentage discount and timeframe, while allowing businesses to drive faster deal closures while offering additional value to clients.

For example, in another embodiments, the system further includes a completely editable pricing field to provide maximum flexibility in customized agreements. For instance, the system may allow customized pricing structures, such as offering 1 complimentary service month for a 1-year agreement, 2 complimentary months for a 2-year agreement, and 3 complimentary months for a 3-year agreement. Additionally, the system may support adjustments for unique terms, such as higher quantities or bundled services, thereby ensuring that pricing is adaptable to specific client scenarios.

By combining standardized pricing mechanisms, configurable time-sensitive incentives, and customizable fields, the disclosed system ensures that clients receive optimal pricing based on their individual needs and preferences, while enhancing client satisfaction, accelerates decision-making processes, and fosters long-term business relationships.

In some embodiments, as long as the lead meets their agreed-upon requirements, such as providing their buying timeline and designating a Single Point of Contact (SPOC), their best pricing eligibility remains intact. If an agent does not meet performance expectations, the company has the flexibility to reassign the lead to another agent without impacting the lead's best pricing eligibility status. In this way, it is ensured that best pricing is a stable, predictable benefit for the leads, based solely on their own engagement and commitments.

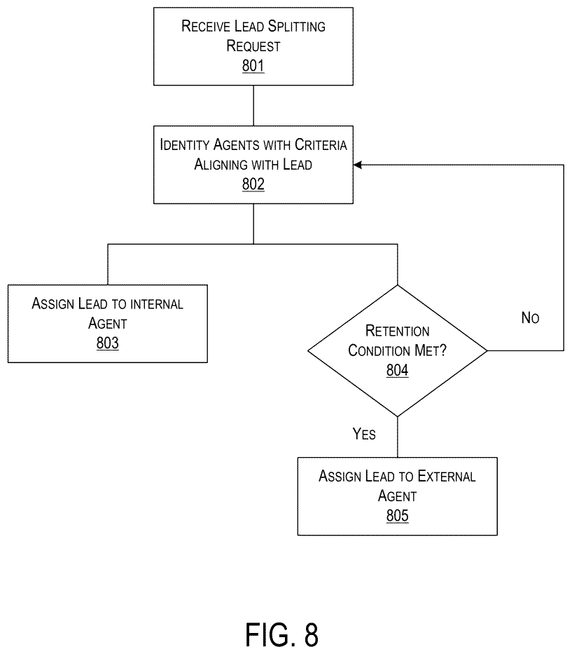

In an exemplary embodiment, the lead management module 102 splits a between internal employees of the organization and external agents, for supporting collaborative lead handling and ensuring lead distribution aligns with team expertise and availability. Referring FIG. 8, the lead splitting request is received 801 in the lead management system 100. The lead management module 102 includes a lead split toggle 806 to allow splitting the lead when the toggle 806 is activated. The lead management module 102 is configured to identify 802 if the internal and external agents'qualifications are aligning with the lead to be split. If the qualifications of internal agents are met, the lead is assigned 803 to the internal agent. If the qualifications of external agents are met, the lead is assigned 804 to the external agent. Before assigning 804 to the external agents, the lead management module 102 identifies 805 if the agent satisfied the retention condition as discussed in FIG. 3. If the retention conditions are satisfied, the lead is assigned 806 to the external agent. If the retention conditions are not satisfied, another agent is identified to assign the lead. For instance, if a particular agent is performing exceptionally well with high-value leads, the system 100 can toggle lead split to assign them additional priority leads while redistributing lower-value leads to other agents.

The real-time toggling function allows organizations to adapt to changing lead needs or agent availability, thus optimizing response times and lead engagement outcomes. This dynamic control is key to maintaining responsiveness in fast-paced lead environments. In an exemplary aspect, the lead management module includes a lead split capability that allows leads to be assigned to multiple agents or teams, which is subject to an integrated approval process that gives organizational control over any proposed lead splits. To ensure secure communication, the communication module 103 is configured to assign a Direct Inward Dialing (DID) number for each lead, thereby allowing for SPOC-based contact while safeguarding lead confidentiality. In one aspect, the communication module 103 includes a communication toggle 901, which when activated, allow agents to contact leads by masking the contact details of the leads to maintain lead privacy, aligning with compliance requirements. This capability protects sensitive information in environments involving in-house agents, independent contractors or third-party agents, where the risk of data exposure may be higher. In one aspect, the present invention utilizes Twilio for DID assignment and communication masking. DID masking is a required, company-controlled aspect which is activated when a prospect designates an agent, whether independent or direct company sales, as their single point of contact. This mechanism ensures secure communication and compliance within the single point of contact arrangement.

In some embodiments, the communication module 103 allows organizations to toggle data accessibility and sharing among agents using a data accessibility toggle 902. For instance, if the data accessibility toggle 902 is activated, the module 103 may restrict certain lead details to be viewable only by authorized personnel, and these permissions can be toggled as agents switch or as compliance needs evolve. The toggling capability also supports secure data sharing with external agents, granting or rescinding access as necessary based on organizational rules.

The central database 207, 307 acts as a repository for all lead-related data, including status updates, agent scores, and customer preferences. In some aspects, the present invention is integrated with on-premise or cloud-based centralized database management such as Amazon RDS or MySQL. In various aspects, the centralized storage supports real-time data retrieval for lead tracking and reporting, making it possible for organizations to assess the performance of both leads and agents quickly.

The lead scoring module integrates with the lead management module to provide a toggling mechanism that updates lead prioritization based on engagement level, potential value, and urgency. When a lead's score changes, toggling within the lead management module allows for instant reassignment or redistribution, directing the highest-scoring leads to top-performing agents. This dynamic adjustment ensures that leads with the most potential are handled efficiently, thereby maximizing conversion opportunities.

In an aspect, the agent tracking module is configured with toggling capabilities that enforce specific performance milestones for agents. If an agent fails to meet a required milestone, the system can toggle the lead assignment to another agent automatically, without manual oversight. This ensures continuity in lead handling and supports agent accountability, as the toggling mechanism monitors and reallocates leads in real time based on milestone completion. Additionally, if an agent's performance score exceeds a predefined threshold, the system toggles access to priority leads.

Altogether, the lead management and SPOC control system combines CRM integration, dynamic lead toggling, secure communication controls, and structured compliance mechanisms to efficiently manage leads within an organization. This architecture not only increases agent performance but also ensures a high level of security and compliance for various lead management needs.

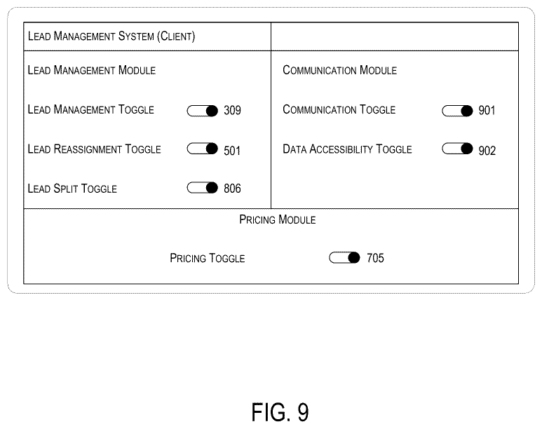

Referring FIG. 9, the toggle-enabled functionalities within the lead management system, which are accessible exclusively by the client organization is depicted. These toggles allow the organization to manage and customize various operational features to suit their requirements effectively. The lead management module includes options such as the lead management toggle 309, which activates or deactivates lead management capabilities. The lead reassignment toggle 501 enables the organization to control whether leads can be reassigned to other agents. Additionally, the lead split toggle 806 determines if leads can be distributed among multiple agents or groups, offering flexibility in lead allocation.

Under communication module, the communication toggle 901 allows the organization to enable or disable communication features, such as calls or messages. The data accessibility toggle 902 governs access permissions for sensitive lead or organizational data, thus ensuring robust data security and control. The pricing toggle 705 focuses on pricing-related actions, such as sharing or rejecting pricing information. This pricing toggle 705 ensures that pricing decisions align with the organization's strategy and compliance requirements. These toggles are accessible only by the organization, i.e. client, ensuring that only authorized personnel or administrators can modify operational settings. This restricted access reinforces security and centralized control, thereby enabling organizations to optimize the system functionalities effectively.

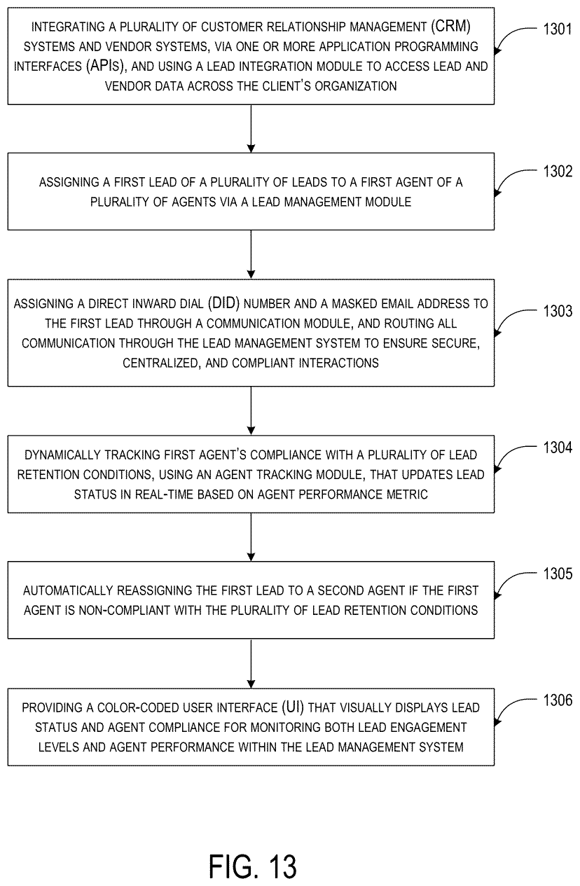

According to an exemplary embodiment, referring FIG. 13, a method for lead management within a CRM system is disclosed. The CRM system is the lead management and SPOC control system as disclosed in the previous embodiment. The method enhances secure and compliant lead engagement across independent and direct sales channels. The method involves integrating 1301 a plurality of external CRM and vendor management platforms with the lead management system via one or more application programming interfaces (APIs). The integration enables access to lead data and vendor information across various organizations and to provide a unified view of leads regardless of source.

The method further includes assigning 1302 leads, using a lead management module, to external agents based on predefined assignment rules and agent performance. The lead management module incorporates toggling functionality to dynamically adjust the assignment of one or more lead contacts, depending on real-time agent performance metrics. By tracking compliance and engagement levels, the lead management module modifies lead assignments while also ensuring that agents only retain leads when they meet the established performance conditions.

In one aspect, each lead is assigned a Single Point of Contact (SPOC) using an SPOC management module. This SPOC management module ensures centralized communication by maintaining SPOC integrity and preventing multiple points of contact for each lead. Further, customers, also referred to as the organization or company, can designate their SPOC preferences, allowing them to manage and control communications with designated agents effectively. The centralized communication is supported by the assignment 1303 of Direct Inward Dial (DID) numbers and a masked email address to each lead, which routes all communications through the communication module to maintain data privacy and secure engagement. In an aspect, a pricing module is configured to provide competitive pricing on products or services, contingent upon procurement requirements set by the customer. When customers specify these requirements, the system applies pricing adjustments and communicates offers to potential customers.

In one aspect, lead assignment and compliance rules are enforced using a lead compliance module, thereby adapting dynamically to meet evolving regulatory requirements and company policies. In an exemplary aspect, sensitive lead information is secured, with access controlled based on each agent's compliance status. Further, if an agent fails to meet the required conditions, access to the lead is modified or revoked. The lead status updates, agent performance scores, and customer-defined preferences are stored within a central database, using the lead assignment compliance module, while enabling real-time monitoring of agent compliance and lead status.

In a specific aspect, the lead management module continuously provides real-time updates on lead status and progress, while allowing organizations to monitor advancements and take immediate action when required. Further, lead prioritization is dynamically managed, with urgent leads distributed based on agent performance metrics to ensure optimal engagement and conversion potential.

In certain aspects, DID numbers are assigned to each lead contact to maintain privacy, thereby masking the lead's phone number. This ensures compliance with Do Not Call (DNC) regulations by rerouting communications to a compliant DID, such that the direct exposure of lead contact information to agents is prevented, while maintaining security and regulatory adherence.

In an aspect, the milestones of external agents are dynamically tracked 1304 using an agent tracking module to retain lead assignments. The milestones include a plurality of lead retention conditions. The system tracks these milestones, and if agents fail to meet predefined thresholds, the lead is flagged for reassignment 1305, ensuring that only qualified and compliant agents handle lead engagements. Further, in some aspects, a color-coded interface is visually displayed 1306 to depict lead status and agent compliance levels for monitoring by the customer, thereby providing insight into compliance and engagement status.

Utilizing the present invention, the companies are allowed to control over lead assignments to agents, interactions with leads, and selecting communication preferences that best meet their needs. In some embodiments, the leads define the timing, method, and nature of interactions they are interested in, which ensures that agents respond accurately to customer expectations. Masked DID numbers and email addresses safeguard sensitive information, which ensures secure, compliant communication across all communication medium. Companies are also allowed to enforce retention conditions tied to agent performance, minimizing lead misuse and maximizing engagement. The present invention is configured to integrate existing CRM systems via open APIs without the need for significant restructuring. The color-coded interface provides efficient compliance tracking and lead management, while reducing complexity for managers and enhancing decision-making.

In an embodiment, the system enables independent agents to sell any of the client's services, including lead management, vendor management, or other modular components, as freelancers on the open market. The system functions as a marketplace where agents act as autonomous sellers, to customers tailored to their specific needs. To implement this example, agents first enroll with the platform (i.e. the lead management system) through an agent registration process. Once registered, the agents gain access to a comprehensive catalog of services that they can market and sell. The catalog includes, but is not limited to: lead management system which provides centralized lead tracking, single point of contact (SPOC) functionality, and milestone monitoring to help businesses streamline their lead processes; vendor management module which offers streamlined vendor registration, compliance tracking, and enforcement of specific requirements, ensuring efficient vendor management; and custom configurations by which agents can create solutions by combining various system components to meet the needs of their customers.

The marketplace features a suite of tools designed to empower agents in marketing, customizing, and pricing services effectively. The system handles all backend operations, including ensuring compliance, provisioning services, and delivering regular software updates. These operational assurances allow agents to focus on selling and providing value to customers without being burdened by administrative or technical concerns. Agents earn commissions or recurring revenue based on their sales performance. The system tracks these performances transparently, ensuring agents have clear visibility into their earnings and contributions, thereby evaluating the effectiveness and engagement levels of its freelance agent network. When leads are onboarded through an agent, they gain full access to the purchased services. The system is designed to enable seamless scalability, allowing customers to expand their usage or adopt additional services as their needs evolve. The system ensures that customers receive continuous support and value throughout their engagement with the platform.

For example, consider Alex, an independent agent operating as a freelancer. Alex identifies a mid-sized company struggling with lead management inefficiencies. Recognizing the company's need, Alex sells them the lead management system as a standalone service. The company (i.e. the client) benefits from centralized lead tracking, SPOC assignment, and milestone monitoring, while Alex earns a commission for the sale. In another instance, Alex connects with a large retail chain that faces challenges in maintaining vendor compliance. Alex offers them the vendor management module, which enables the retail chain to enforce vendor requirements more effectively. The retail chain experiences improved compliance and streamlined vendor operations, while Alex gains recurring revenue from the module's subscription. The system, in turn, provides ongoing backend support and updates to ensure the customers receive optimal performance.

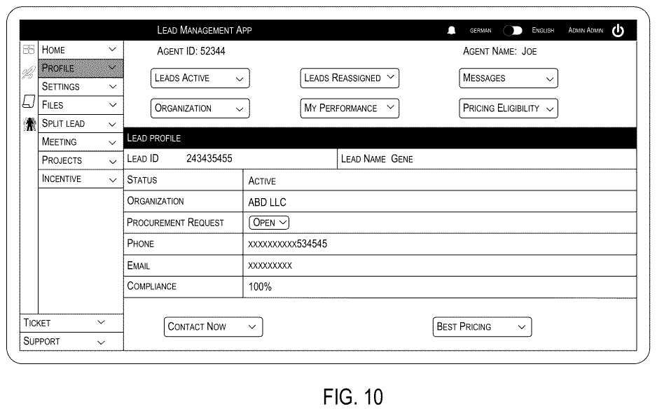

For example, FIG. 10 provides a detailed representation of the agent-facing user interface (UI) within the lead management system 100. The user interface serves as a centralized workspace where agents can view and manage their assigned leads, track performance metrics, and engage with other key operational functionalities.

The UI displays details about each lead in a structured format. These details include lead name and ID; organization information which includes the organization associated with the lead; lead status which displays current status of the lead (e.g., active, in progress, or closed) that allows the agent to prioritize follow-up actions; procurement requests, which if applicable, procurement-related requests or requirements are shown, enabling the agent to address them promptly; lead's masked contact details; compliance status which is a visible indicator that shows whether the lead meets all defined compliance requirements; operational controls and actions in the form of actionable buttons and toggles that allow agents to take specific actions for better lead management; the operational controls and actions includes contact now option that allows the agent to initiate direct communication with the lead, using the platform's secure communication channels and best pricing option which displays lead's eligibility for competitive pricing options while enabling agents to leverage cost advantages during discussions; and agent performance metrics such as leads active, i.e. the number of active leads currently being managed; leads reassigned which provides historical data on reassigned leads; messages option that leads to a streamlined inbox or notification system for communication between the agent, team members, and system administrators; and my performance option which provides a visual summary of key metrics, such as response times, engagement levels, and compliance adherence. In addition, the UI supports integration with multiple system modules and displays administrative controls for efficient navigation. Multilingual support (e.g., English, German, French) ensures inclusivity, that allows agents from diverse backgrounds to utilize the platform effectively. The UI further incorporates color-coded indicators for compliance status and lead activity, to enhance usability.

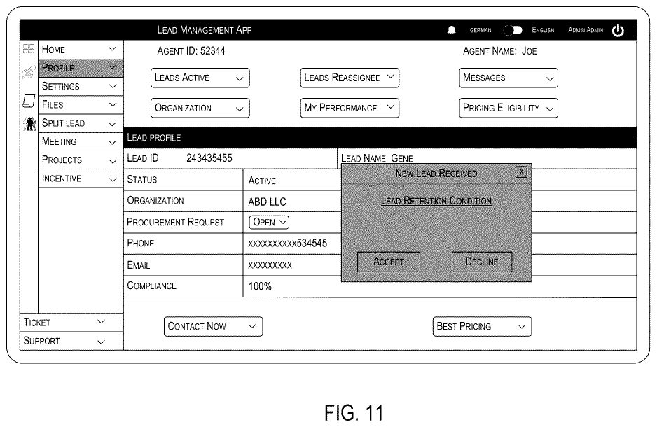

FIG. 11 illustrates an agent-facing user interface (UI) within the lead management application 100, designed to streamline lead engagement and operational efficiency. The UI displays an agent's profile, including their ID and status (e.g., active), alongside performance metrics such as active leads, reassigned leads, and compliance status. A notification system alerts agents to newly assigned leads, prompting them to accept or decline retention conditions using clear “Accept” or “Decline” buttons. The dashboard integrates tools for scheduling meetings, managing files, tracking incentives, and accessing ticket-based support, by creating a centralized workspace. Additionally, discussed earlier, the lead profile view includes details such as lead name, ID, status, organization, procurement requests, and compliance status, alongside quick-action buttons like “Contact Now” and “Best Pricing” to facilitate secure communication and negotiation.

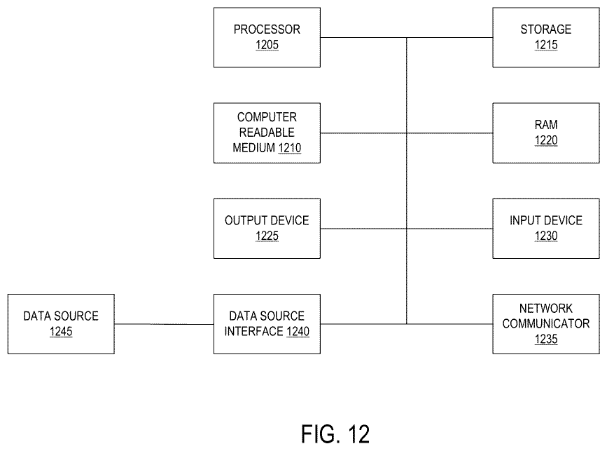

In one embodiment, referring FIG. 12, a computer system is disclosed which is used for implementing the lead management system 100, thus ensuring seamless operation, secure data handling, and scalability. The computer system includes around a processing unit 1205, which serves as the core computational hub. The processing unit 1205 is responsible for executing application logic, managing workflows, and processing requests from agents and administrators. Tasks such as lead assignment, compliance monitoring, performance evaluation, and API interactions are managed through the processing unit 1205. The processing unit 1205 leverages one or more algorithms. The algorithms include lead scoring algorithm to prioritizes leads based on engagement and potential value, while a compliance monitoring algorithm tracks adherence to retention conditions and engagement protocols, triggering reassignment when necessary. A retention validation algorithm evaluates whether retention conditions are met, and an agent performance scoring algorithm analyzes metrics like response time and compliance to generate performance scores. A dynamic pricing eligibility algorithm determines eligibility for pricing benefits based on predefined criteria. Additionally, a lead assignment optimization algorithm matches leads to agents based on availability and success rates, and a data synchronization algorithm ensures real-time consistency across devices and external CRMs. The bidirectional data integration algorithm facilitates seamless data exchange with external systems, while a security algorithm protects sensitive information through encryption and access controls, ensuring the system remains secure and reliable. The processing unit 1205 executes the application logic that governs the toggling functionality. It processes user inputs related to toggles, such as lead assignment toggles, compliance status toggles, or reassignment toggles. The processing unit 1205 is configured to ensure that the toggles'state (e.g., ON/OFF) reflects real-time conditions, such as agent compliance or lead status.

Further, supporting the processing unit is a computer-readable medium 1210, which stores software, algorithms, and configuration files. The computer-readable medium 1210 is dynamically updated to ensure the system remains adaptable to evolving requirements, such as regulatory compliance or feature enhancements. The computer system includes data encryption mechanisms for protecting sensitive information stored within the computer-readable medium 1210. By enabling seamless updates, the computer-readable medium 1210 ensures the system maintains its capabilities without downtime.

The data storage 1215 provides a dual-layered structure to manage both temporary and persistent data effectively. RAM 1220 handles real-time processing needs, such as updating dashboards or generating performance metrics, ensuring low-latency operations. Long-term storage solutions within this component retain lead histories, agent performance records, and customer feedback. The dual functionality ensures the system can deliver both instantaneous updates and historical insights to its users.

Input devices 1230 and output devices 1225 allow agents and administrators to interact with the system. Input devices enable users to enter data, such as agent credentials, customer feedback, or compliance updates. Further, these devices, such as keyboards or touchscreens, allow agents to interact with the system and change toggle states manually. Meanwhile, output devices 1225 render user-friendly interfaces, such as dashboards, reports, and notifications, across a range of devices, including desktops, tablets, and smartphones. The output devices 1225 display the current state of toggles in the user interface (e.g., ON or OFF), providing agents with immediate feedback on their actions and the system's response. These interfaces are synchronized in real-time through a network communicator 1225, which uses secure protocols to maintain the integrity and confidentiality of data exchanges.

The computer system also integrates with external data sources via a data source interface 1240, 1245. The interface enables the system to import real-time updates from third-party CRMs, compliance databases, and procurement systems, thereby ensuring the platform remains up-to-date. Additionally, bidirectional communication capabilities allow updates made in to propagate back to these external systems. With this architecture of computer system, the platform can grow alongside the client's needs, handling increasing data volumes and integrations while maintaining peak performance, thereby enhancing lead management efficiently.

An example software ecosystem of the lead management system 100 is disclosed herein. The backend operations of lead management system 100 are managed by software frameworks like Python such as Django or Java such as Spring Boot, hosted on the processing unit 1205. These frameworks execute core business logic, including lead scoring, compliance monitoring, and toggling functionality. The PostgreSQL database, integrated with the storage 1215, manages structured data like lead details, agent records, and performance metrics, while Redis may act as an in-memory store for real-time data such as toggle states. The GraphQL or RESTful API layer, interfaces through the data source interface 1240, 1245, to facilitate communication between the lead management system and external CRMs or compliance systems for dynamic data integration.

The frontend software for user interface, visualized on output devices 1225 like desktops, is implemented by frameworks such as ReactJS or Angular. The dynamic and responsive nature of these tools enabling agents to interact with dashboards, toggle leads, and view performance metrics. Redux or NgRx handles state management, thus ensuring consistent UI updates across user sessions. The design of the user interface is prototyped using tools like Figma or Adobe XD to provide intuitive layouts and a user-friendly experience. Input devices such as keyboards or touchscreens allow agents to interact with the system, while visual elements like toggles and performance graphs are rendered using libraries such as D3.js or Chart.js.

Real-time updates for lead status changes, toggles, and notifications are facilitated through WebSocket Protocol, implemented via Socket.IO for Node.js or SignalR for .NET. These tools synchronize data between agents and the server in real-time. The network communicator maintains secure, encrypted connections using protocols such as Transport Layer Security (TLS), thereby ensuring confidentiality and integrity of data exchanges. Predictive analytics, such as lead scoring and agent performance evaluations, are handled by machine learning frameworks like TensorFlow or PyTorch, executed on the processing unit 1205. Lightweight models for real-time tasks, such as retention condition validation, use Scikit-learn for efficiency. The processing unit processes these predictions and updates data dynamically in the storage 1215, thus allowing agents to receive insights directly on their dashboard. Data visualization tools, integrated within the frontend, represent this information graphically, aiding decision-making.

The computer system employs robust security frameworks such as OpenSSL and Vault by HashiCorp for encrypting sensitive data stored in the computer-readable medium 1210 or transmitted via a network communicator 1235. Access control is implemented using OAuth 2.0 and JWT (JSON Web Tokens), thus allowing only authenticated agents and administrators can access restricted features like toggling or lead assignments. These measures, integrated within the backend and network layers, maintain the platform's compliance with data protection standards. The backend processes and network activity are continuously monitored using tools like Prometheus and Grafana, which track metrics such as toggle usage and system health. Sentry identifies and resolves errors in the frontend or backend, ensuring uninterrupted service. The lead management system is deployed on platforms like AWS (Amazon Web Services) or Microsoft Azure, leveraging their scalability and reliability. The processing unit 1205 orchestrates containerized services via Kubernetes for updates and high availability. This software ecosystem is distributed across the components of the computer system as shown in FIG. 12, for seamless integration of backend logic, real-time communication, secure data handling, and an intuitive user interface. Together, these elements enable the lead management system to deliver an efficient and enhanced lead management solution.

It will finally be understood that the disclosed embodiments are presently preferred examples of how to make and use the claimed invention, and are intended to be explanatory rather than limiting the scope of the invention as defined by the claims below. Reasonable variations and modifications of the illustrated examples in the foregoing written specification and drawings are possible without departing from the scope of the invention as defined in the claim below. It should further be understood that to the extent the term “invention” is used in the written specification, it is not to be construed as a limited term as to number of claimed or disclosed inventions or the scope of any such invention, but as a term which has long been conveniently and widely used to describe new and useful improvements in technology. The scope of the invention supported by the above disclosure should accordingly be construed within the scope of what it teaches and suggests to those skilled in the art, and within the scope of any claims that the above disclosure supports. The scope of the invention is accordingly defined by the following claims.

This application is intended to cover any adaptations or variations of the present invention. Therefore, it is manifestly intended that this invention be limited only by the claims and the equivalents thereof.

1. A method comprising:
integrating a plurality of customer relationship management (CRM) systems and vendor systems into a lead management system, via one or more application programming interfaces (APIs), and using a lead integration module to access lead and vendor data across the client's organization;
assigning a first lead of a plurality of leads to a first agent of a plurality of agents via a lead management module;
assigning a direct inward dial (DID) number and a masked email address to the first lead through a communication module, and routing all communication through the lead management system to ensure secure, centralized, and compliant interactions;
dynamically tracking first agent's compliance with a plurality of lead retention conditions, using an agent tracking module, that updates lead status in real-time based on agent performance metrics;
automatically reassigning the first lead to a second agent if the first agent is non-compliant with the plurality of lead retention conditions; and
providing a color-coded user interface (UI) that visually displays lead status and agent compliance for monitoring both lead engagement levels and agent performance within the lead management system.

2. The method of claim 1, wherein the plurality of lead retention conditions are defined within the lead management system by the organization.

3. The method of claim 1, wherein the lead management module allows the first agent to access the first lead only after acknowledging the defined retention conditions.

4. The method of claim 1, wherein the assigning includes:
a. determining if the lead assignment toggle is ON or OFF;
b. presenting a plurality of lead retention conditions to the first agent, for acknowledgement by the agent, if the lead assignment toggle is ON;
c. determining if the agent acknowledges the lead retention conditions;
d. assigning the first lead to the first agent if lead retention conditions are acknowledged by the first agent; and
e. reassigning the first lead if the first agent failed to acknowledge lead retention conditions.

5. The method of claim 1, wherein the reassigning includes:
a. determining if the lead reassignment toggle is ON or OFF;
b. reassigning the first lead to the second agent if the reassignment toggle is ON; and
c. alerting the client of the agent's non-compliance of lead retention conditions if the
reassignment toggle is OFF.

6. The method of claim 1, wherein the plurality of lead retention conditions includes the level of threshold to maintain for one or more performance parameters including agent's response time, follow-up frequency, lead status tracking, compliance with protocols of organization, engagement matrix, availability, satisfaction or feedback rate, and target achievement.

7. The method of claim 1, wherein if one or more lead retention conditions of the first agent are below the threshold, then the first lead is reassigned to the second agent.

8. The method of claim 1, further comprising utilizing a pricing module to provide competitive pricing, on services or products, to one or more of the plurality of leads based on satisfying best pricing eligibility conditions, wherein the best pricing eligibility conditions include:
the leads submitting their procurement requirements of the services or products within predefined time;
satisfying one or more performance parameters by the agent; and
predefined customized requirements for different lead.

9. The method of claim 8, wherein the best pricing eligibility conditions are analyzed and enhanced by artificial intelligence (AI)/machine learning (ML) algorithms for predictive insights and dynamic adjustments.

10. The method of claim 8, wherein the providing competitive pricing further comprising:
a. determining if the pricing toggle is ON or OFF;
b. determining if the best pricing eligibility conditions are satisfied if pricing toggle is ON; and
c. providing competitive pricing to the lead.

11. The method of claim 1, further comprising:
enabling lead splitting between internal employees of the organization and external agents, thereby supporting collaborative lead handling and ensuring lead distribution aligns with team expertise and availability.

12. A system comprising a processor and memory, wherein the processor and memory in combination are operable to implement a method comprising:
integrating a plurality of customer relationship management (CRM) systems and vendor systems into a lead management system, via one or more application programming interfaces (APIs), and using a lead integration module to access lead and vendor data across the client's organization;
assigning a first lead of a plurality of leads to a first agent of a plurality of agents via a lead management module;
assigning a direct inward dial (DID) number and a masked email address to the first lead through a communication module, and routing all communication through the lead management system to ensure secure, centralized, and compliant interactions;
dynamically tracking first agent's compliance with a plurality of lead retention conditions, using an agent tracking module, that updates lead status in real-time based on agent performance metrics;
automatically reassigning the first lead to a second agent if the first agent is non-compliant with the plurality of lead retention conditions; and
providing a color-coded user interface (UI) that visually displays lead status and agent compliance for monitoring both lead engagement levels and agent performance within the lead management system.

13. The system of claim 12, wherein the plurality of lead retention conditions are defined within the lead management system by the organization.

14. The system of claim 12, wherein the lead management module allows the first agent to access the first lead only after acknowledging the defined retention conditions.

15. The system of claim 12, wherein the assigning includes:
a. determining if the lead assignment toggle is ON or OFF;
b. presenting a plurality of lead retention conditions to the first agent, for acknowledgement by the agent, if the lead assignment toggle is ON;
c. determining if the agent acknowledges the lead retention conditions;
d. assigning the first lead to the first agent if lead retention conditions are acknowledged by the first agent; and
e. reassigning the first lead if the first agent failed to acknowledge lead retention conditions.

16. The system of claim 12, wherein the reassigning includes:
a. determining if the lead reassignment toggle is ON or OFF;
b. reassigning the first lead to the second agent if the reassignment toggle is ON; and
c. alerting the client of the agent's non-compliance of lead retention conditions if the reassignment toggle is OFF.

17. The system of claim 12, wherein the plurality of lead retention conditions includes the level of threshold to maintain for one or more performance parameters including agent's response time, follow-up frequency, lead status tracking, compliance with protocols of organization, engagement matrix, availability, satisfaction or feedback rate, and target achievement.

18. The system of claim 12, wherein if one or more lead retention conditions of the first agent are below the threshold, then the first lead is reassigned to the second agent.

19. The system of claim 12, further comprising utilizing a pricing module to provide competitive pricing, on services or products, to one or more of the plurality of leads based on satisfying best pricing eligibility conditions, wherein the best pricing eligibility conditions include:
the leads submitting their procurement requirements of the services or products within predefined time;
satisfying one or more performance parameters by the agent; and
predefined customized requirements for different lead.

20. The system of claim 19, wherein the best pricing eligibility conditions are analyzed and enhanced by artificial intelligence (AI)/machine learning (ML) algorithms for predictive insights and dynamic adjustments.

21. The system of claim 19, wherein the providing competitive pricing further comprising:
a. determining if the pricing toggle is ON or OFF;
b. determining if the best pricing eligibility conditions are satisfied if pricing toggle is ON; and
c. providing competitive pricing to the lead.

22. The system of claim 12, further comprising:
enabling lead splitting between internal employees of the organization and external agents, thereby supporting collaborative lead handling and ensuring lead distribution aligns with team expertise and availability.

23. A computer-program product comprising a non-transitory computer-usable medium having computer-readable program code embodied therein, the computer-readable program code adapted to be executed to implement a method comprising:
integrating a plurality of customer relationship management (CRM) systems and vendor systems into a lead management system, via one or more application programming interfaces (APIs), and using a lead integration module to access lead and vendor data across the client's organization;
assigning a first lead of a plurality of leads to a first agent of a plurality of agents via a lead management module;
assigning a direct inward dial (DID) number and a masked email address to the first lead through a communication module, and routing all communication through the lead management system to ensure secure, centralized, and compliant interactions;
dynamically tracking first agent's compliance with a plurality of lead retention conditions, using an agent tracking module, that updates lead status in real-time based on agent performance metrics;
automatically reassigning the first lead to a second agent if the first agent is non-compliant with the plurality of lead retention conditions; and
providing a color-coded user interface (UI) that visually displays lead status and agent compliance for monitoring both lead engagement levels and agent performance within the lead management system.
